(19) United States
(12) Patent Application Publication
(10) Pub. No.: US 2026/0238393 A1
(43) Pub. Date: Aug. 13, 2026

(54) TIMER BASED RADIO LINK CONTROL (RLC) ACKNOWLEDGED MODE (AM) RECEIVING WINDOW (RX WIN) ADVANCE

(71) Applicant: Telefonaktiebolaget LM Ericsson (publ), Stockholm (SE)

(72) Inventors: Samir SHAH, Ottawa (CA); Selva SOMASUNDARAM, Ottawa (CA)

(21) Appl. No.: 19/149,723

(22) PCT Filed: Feb. 13, 2024
(86) PCT No.: PCT/IB2024/051343

§ 371 Date: Jul. 21, 2025

Related U.S. Application Data
(60) Provisional application No. 63/485,074, filed on Feb. 15, 2023.

(51) Int. Cl. H04L 1/1829; H04L 1/1607

(52) U.S. Cl. CPC H04L 1/1832; H04L 1/1685; H04L 1/1848

(57) ABSTRACT

A method, system and apparatus are disclosed. In at least one embodiment, a network node is configured to communicate with a wireless device (WD). The network node comprises processing circuitry. The processing circuitry is configured to configure a radio link control, RLC, timer, the timer corresponding to a maximum wait time for a missing data convergence protocol, PDCP, sequence number, SN. The processing circuitry is configured to advance an RLC receiving window based on the missing PDCP SN being one of received and not received before an expiration of the RLC timer.

### TECHNICAL FIELD

The present disclosure relates to wireless communications, and in particular, to advancing a receive window.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

NR radio link control (RLC), as specified in, e.g., 3GPP Technical Specification (T.S.) 38.322, provides functionality for transfer of upper layer PDUs and supports 3 RLC modes: transparent mode (TM), unacknowledged mode (UM), and acknowledged mode (AM).

For NR RLC AM, a RLC sequence number (SN) is associated with one RLC SDU service data unit (packet data convergence protocol (PDCP) protocol data unit (PDU)). All RLC PDUs carrying data for a segmented RLC SDU carry the same RLC SN.

RLC AM layer is used to provide reliable delivery of upper layer PDUs through error correction through automatic repeat request (ARQ) retransmissions, segmentation and reassembly of RLC SDUs, re-segmentation of RLC SDU segments, and duplicate detection.

As an RLC AM receiver, RLC SDU segments for RLC SDUs not fully reassembled need to be buffered at RLC layer until all the missing segments of RLC SDU are received. Fully received RLC SDUs within the RLC receive window that are not duplicates are passed to PDCP receiver. RLC transmitter polls for STATUS feedback from RLC receiver. RLC AM transmitter uses the STATUS feedback from receiver to know if RLC receiver received all the transmitted data and will perform RLC ARQ retransmission of missing (i.e., not-acknowledged (NACK)) data up to maxRetxThreshold times before ending the retransmission process and declaring radio link failure (RLF).

In NR PDCP (e.g., as specified in 3GPP T.S. 38.323), the PDCP receiving entity provides functionality for deciphering, integrity verification, header decompression, duplicate discarding, and reordering and in-order delivery. Optionally, the bearer may be configured to allow out-of-order delivery.

Each PDCP SDU is associated with one PDCP SN and encapsulated in one PDCP PDU. The PDCP receiver uses an internal state variable hyper frame number (HFN) and the received PDCP SN to compute a 32-bit RCVD_COUNT. A RX_DELIV state variable is used to track the lower edge of the PDCP receive window size that is typically half the PDCP SN space. PDCP PDUs received with RCVD_COUNT<RX_DELIV are discarded.

PDCP receive operation actions, e.g., as specified in 3GPP T.S. 38.323, details the follows:

Actions when a PDCP Data PDU is Received from Lower Layers

As used below, the following definitions are used:
HFN (State Variable): the HFN part (i.e., the number of most significant bits equal to HFN length) of the State Variable;
SN (State Variable): the SN part (i.e., the number of least significant bits equal to PDCP SN length) of the State Variable;
RCVD_SN: the PDCP SN of the received PDCP Data PDU, included in the PDU header;
RCVD_HFN: the HFN of the received PDCP Data PDU, calculated by the receiving PDCP entity;
RCVD_COUNT: the COUNT of the received PDCP Data PDU=[RCVD_HFN, RCVD_SN].

At reception of a PDCP Data PDU from lower layers, the receiving PDCP entity determines the COUNT value of the received PDCP Data PDU, i.e., RCVD_COUNT, as follows:

```
- if RCVD_SN < SN(RX_DELIV) − Window_Size:
  ∘ RCVD_HFN = HFN(RX_DELIV) + 1.
- else if RCVD_SN >= SN(RX_DELIV) + Window_Size:
  ∘ RCVD_HFN = HFN(RX_DELIV) − 1.
- else:
  ∘ RCVD_HFN = HFN(RX_DELIV);
- RCVD_COUNT = [RCVD_HFN, RCVD_SN].
```

After determining the COUNT value of the received PDCP Data PDU=RCVD_COUNT, the receiving PDCP entity shall:

| - | perform deciphering and integrity verification of the PDCP Data PDU using | |
|---|---|---|
| | COUNT = RCVD_COUNT; | |
| - | if integrity verification fails: | |
| | ∘ | indicate the integrity verification failure to upper layer; |
| | ∘ | discard the PDCP Data PDU and consider it as not received; |
| - | if RCVD_COUNT < RX_DELIV; or | |
| - | if the PDCP Data PDU with COUNT = RCVD_COUNT has been received before: | |
| | ∘ | discard the PDCP Data PDU; |

If the received PDCP Data PDU with COUNT value = RCVD_COUNT is not discarded
above, the receiving PDCP entity shall :

| - | store the resulting PDCP SDU in the reception buffer; | |
|---|---|---|
| - | if RCVD_COUNT >= RX_NEXT: | |
| | ∘ | update RX_NEXT to RCVD_COUNT + 1. |
| - | if outOfOrderDelivery is configured: | |
| | ∘ | deliver the resulting PDCP SDU to upper layers after performing header |
| | | decompression using EHC. |
| - | if RCVD_COUNT = RX_DELIV: | |
| | ∘ | deliver to upper layers in ascending order of the associated COUNT value |
| | | after performing header decompression, if not decompressed before; |
| | ∘ | all stored PDCP SDU(s) with consecutively associated COUNT value(s) |
| | | starting from COUNT = RX_DELIV; |
| | ∘ | update RX_DELIV to the COUNT value of the first PDCP SDU which has |
| | | not been delivered to upper layers, with COUNT value > RX_DELIV; |
| - | if t-Reordering is running, and if RX_DELIV >= RX_REORD: | |
| | ∘ | stop and reset t-Reordering. |
| - | if t-Reordering is not running (includes the case when t-Reordering is stopped due to | |
| | actions above), and RX_DELIV < RX_NEXT: | |
| | ∘ | update RX_REORD to RX_NEXT; |
| | ∘ | start t-Reordering. |

Actions when a t-Reordering expires
When t-Reordering expires, the receiving PDCP entity shall:

| - | deliver to upper layers in ascending order of the associated COUNT value after | |
|---|---|---|
| | performing header decompression, if not decompressed before: | |
| | ∘ | all stored PDCP SDU(s) with associated COUNT value(s) < RX_REORD; |
| | ∘ | all stored PDCP SDU(s) with consecutively associated COUNT value(s) |
| | | starting from RX_REORD; |
| - | update RX_DELIV to the COUNT value of the first PDCP SDU which has not been | |
| | delivered to upper layers, with COUNT value >= RX_REORD; | |
| - | if RX_DELIV < RX_NEXT: | |
| | ∘ | update RX_REORD to RX_NEXT; |
| | ∘ | start t-Reordering. |

The RLC AM receiver operations are outlined in, e.g., 3GPP T.S. 38.322 as follows:

### General

The receiving side of an AM RLC entity shall maintain a receiving window according to the state variable RX_Next as follows:

| | |
|---|---|
| - | a SN falls within the receiving window if RX_Next <= SN < |
| | RX_Next + AM_Window_Size; |
| - | a SN falls outside of the receiving window otherwise. |

When receiving an acknowledged mode data (AMD) PDU from lower layer, the receiving side of an AM RLC entity shall:
either discard the received AMD PDU or place it in the reception buffer (see clause Actions when an AM PDU is received from lower layer);
if the received AMD PDU was placed in the reception buffer:
   update state variables, reassemble and deliver RLC SDUs to upper layer and start/stop t-Reassembly as needed (see clause Actions when an AM PDU is placed in reception buffer).
      When t-Reassembly expires, the receiving side of an AM RLC entity shall:
update state variables and start t-Reassembly as needed (see clause Action when t-Reassembly expires).
   Actions when an AMD PDU is Received from Lower Layer
   When an AMD PDU is received from lower layer, where the AMD PDU contains byte segment numbers y to z of an RLC SDU with SN=x, the receiving side of an AM RLC entity shall:

| - | if x falls outside of the receiving window; or | |
|---|---|---|
| - | if byte segment numbers y to z of the RLC SDU with SN = x have been received | |
| | before: | |
| | ∘ | discard the received AMD PDU. |
| - | else: | |
| | ∘ | place the received AMD PDU in the reception buffer; |
| | ∘ | if some byte segments of the RLC SDU contained in the AMD PDU have |
| | | been received before: |
| | | ▪ discard the duplicate byte segments. |

Actions when an AMD PDU is Placed in the Reception Buffer

When an AMD PDU with SN=x is placed in the reception buffer, the receiving side of an AM RLC entity shall:

| - | if x >= RX_Next_Highest: | | |
|---|---|---|---|
| | ∘ | update RX_Next_Highest to x+ 1. | |
| - | if all bytes of the RLC SDU with SN = x are received: | | |
| | ∘ | reassemble the RLC SDU from AMD PDU(s) with SN = x, remove RLC | |
| | | headers when doing so and deliver the reassembled RLC SDU to upper | |
| | | layer; | |
| | ∘ | if x = RX_Highest_Status: | |
| | | ▪ | update RX_Highest_Status to the SN of the first RLC SDU with SN |
| | | | > current RX_Highest_Status for which not all bytes have been |
| | | | received. |
| | ∘ | if x = RX_Next: | |
| | | ▪ | update RX_Next to the SN of the first RLC SDU with SN > current |

RX_Next for which not all bytes have been received.

| - | if t-Reassembly is running: | |
|---|---|---|
| | ∘ | if RX_Next_Status_Trigger = RX_Next; or |
| | ∘ | if RX_Next_Status_Trigger = RX_Next + 1 and there is no missing byte |
| | | segment of the SDU associated with SN = RX_Next before the last byte of |
| | | all received segments of this SDU; or |
| | ∘ | if RX_Next_Status_Trigger falls outside of the receiving window and |
| | | RX_Next_Status_Trigger is not equal to RX_Next + AM_Window_Size: |
| | ∘ | stop and reset t-Reassembly. |
| - | if t-Reassembly is not running (includes the case t-Reassembly is stopped due to | |
| | actions above): | |
| | ∘ | if RX_Next_Highest> RX_Next +1; or |
| | ∘ | if RX_Next_Highest = RX_Next + 1 and there is at least one missing byte |
| | | segment of the SDU associated with SN = RX_Next before the last byte of |
| | | all received segments of this SDU: |

| | |
|---|---|
| ▪ | start t-Reassembly; |
| ▪ | set RX_Next_Status_Trigger to RX_Next_Highest. |

Actions when t-Reassembly expires
When t-Reassembly expires, the receiving side of an AM RLC entity shall:

| - | update RX_Highest_Status to the SN of the first RLC SDU with SN >= | |
|---|---|---|
| | RX_Next_Status_Trigger for which not all bytes have been received; | |
| - | if RX_Next_Highest> RX_Highest_Status +1: or | |
| - | if RX_Next_Highest = RX_Highest_Status + 1 and there is at least one missing | |
| | byte segment of the SDU associated with SN = RX_Highest_Status before the last | |
| | byte of all received segments of this SDU: | |
| | ∘ | start t-Reassembly; |
| | ∘ | set RX_Next_Status_Trigger to RX_Next_Highest. |

A 3GPP NR PDCP receiver entity is configured with a t-Reordering timer that defines the maximum time the PDCP receiver will wait for a missing PDCP COUNT before advancing the lower edge of its receive window. It may be a single timer (t-Reordering), e.g., as defined in 3GPP T.S. 38.323, or two separate timers (e.g., a first timer to wait for missing packets for in-order delivery and a second timer to wait for still missing packets before advancing lower edge of receive window). Regardless of implementation, effectively, there is an upper bound time that PDCP receiver will wait for missing PDCP SN (PDCP COUNT) before advancing the lower edge of PDCP receive window. Any late PDCP PDUs for COUNT values that are outside the PDCP receive window are discarded.

Increasing the PDCP t-Reordering timer increases the amount of time PDCP waits for missing SDUs for in-order-delivery and increasing this time too much can negatively impact TCP performance and interactive applications. It also significantly increases buffering memory requirements in the wireless device and network.

In existing NR RLC specifications, RLC AM layer transmitter/receiver will continue trying to deliver any missing RLC SDUs via ARQ retransmissions to RLC receiver until either successful or until maxRetxThreshold ARQ retransmit attempts for same SDU are reached and Radio Link Failure (RLF) is declared.

When a wireless device is in poor radio frequency (RF) or rapidly changing RF conditions, it is not uncommon for there to be much more RLC SDU segmentation and several HARQ and ARQ retransmissions required to fully receive any missing data. Some SDUs or SDU segments are received quickly but others require multiple rounds of ARQ and HARQ retransmission. If PDCP receiver has successfully received some SDUs but is missing other SDUs with lower effective PDCP COUNT still undergoing HARQ/ARQ retransmissions, it will only wait limited time for these still missing SDU before advancing lower edge of PDCP receive window.

Often PDCP layer is configured with timers in the order of 200-300 msec to wait for missing PDCP SDUs (COUNT) while RLC AM layer is allowed to continue delivering the missing data until up to maxRetxThreshold ARQ retransmission attempts are made which could potentially take several hundreds of milliseconds to a few seconds. This can waste limited resources (air interface radio resources, wireless device battery power, network node/wireless device memory, scheduling resources) where MAC/RLC layer continues to try to deliver data that is no longer within the PDCP receive window and would be discarded when finally received.

On the network node side, the memory resources used to track and store segmented RLC SDUs while waiting for the missing SDU segments are often pooled memory resources shared by all wireless devices. Likewise, the memory resources for PDCP reordering and tracking missing SN may likewise also be a pooled resource shared for all wireless devices. If there are very many wireless devices in poor RF conditions where there is high uplink block error rate (UL BLER) causing lots of RLC SDU segmentation and HARQ/ARQ retransmission, then it is possible that a lot of memory resources are required for buffering and tracking the RLC SDU segments for partially received RLC SDUs in RLC layer and tracking received PDCP SDUs in PDCP reordering buffer while waiting for missing SDUs to be received.

It is possible that these memory resources become exhausted in some extreme scenarios, and then performance for wireless devices in good RF could be negatively impacted by all the buffering resources used by the wireless devices in poor RF.

### SUMMARY

Some embodiments advantageously provide for an RLC timer procedure for advancing a receive window.

One or more embodiments described herein relate to RLC AM mode. In at least one embodiment, a RLC receiver for a radio bearer is aware of the timer configuration used in the PDCP receiver for reordering and receive window advance for same radio bearer. The RLC layer may only need to know what the maximum time the PDCP receiver will wait for a missing PDCP SN (COUNT) once it sees a PDCP SN (COUNT) gap. Such configuration can be provided by L3/RRC software at time of bearer setup.

To do duplication detection, SDU reassembly, and provide reliable delivery through ARQ, the RLC layer already tracks which RLC SDUs have been already received and delivered to the PDCP receiver and which RLC SDUs or RLC SDU segments are still missing. In one or more embodiments, the RLC receiver is enhanced to track the highest RLC SN already delivered to the PDCP layer. If the RLC receiver detects some higher RLC SN is already delivered to PDCP layer while other RLC SN are still missing at lower edge of the RLC receive window, then RLC layer can infer that the PDCP layer must have started its timer(s) for maximum time to wait for missing PDCP SN before advancing PDCP receive window. One or more embodiments implement a similar timer in the RLC AM receiver to limit maximum time the RLC receiver waits to fully receive missing RLC SDU SN if a higher SDU SN has already been given to PDCP layer. The timeout value in RLC should be slightly larger than the maximum time PDCP will wait for a missing PDCP SN before advancing PDCP receive window. If the RLC timer expires before the missing data is received, then the RLC receiver can advance its RLC receive window and trigger a STATUS report indicating to transmitter that it is no longer waiting for that missing data. This functionality can be optionally enabled or disabled on a per bearer basis.

This technique would avoid wasting both network (including, e.g., network node), wireless device, and air interface resources trying to deliver data that will anyways be discarded as out of window by PDCP receiver. Furthermore, it helps reduce buffering resources needed in RLC layer to match what would be useful to PDCP receiver.

This solution is also beneficial for an additional use case such as Time-Critical-Services, where one wants more robust transmission than can be provided using RLC UM alone, but there is a time constraint by which data should be received after which it is better not to wait for late packets. For such services, one may want the extra robustness provided by RLC AM and its ARQ retransmissions, but if the missing packets are not received within some time bound (e.g., 80-200 ms), receiver and transmitter can advance their windows using the scheme outlined in the present disclosure.

Another use case where improvements could be made are for some time-critical services where the reliability provided by RLC UM mode and hybrid ARQ (HARQ) retransmissions alone is not enough, but where there is some timebound above which late packets are not useful and it is better not to wait for late packets. For example, there might be services for which robust delivery within, e.g., 40-200 ms time duration is useful, but packets delivered later than this are not useful, but it may be desirable to have the extra robustness provided by RLC AM and its ARQ retransmissions. Existing RLC AM mode will attempt to deliver the packets until successful or RLF declared long after PDCP receiver and end application has given up waiting for the packets.

According to one aspect of the present disclosure, a network node configured to communicate with a wireless device is provided. The network node is configured to configure a radio link control (RLC) timer, the timer corresponding to a maximum wait time for a missing packet data convergence protocol (PDCP) sequence number (SN); and advance an RLC receiving window based on the missing PDCP SN being one of received and not received before an expiration of the RLC timer.

According to one or more embodiments of this aspect, the timer is a RLC Acknowledged Mode (RLC AM) timer and includes a duration, the duration being based on a maximum wait time for a missing PDCP SN of an associated PDCP receiver.

According to one or more embodiments of this aspect, the network node is further configured to: discard partially received RLC service data unit, SDU, SN data corresponding to the missing SN; and the discarding being based on the missing SN not being received before the expiration of the RLC timer.

According to one or more embodiments of this aspect, the network node is further configured to trigger a status report based on the missing SN not being received before the expiration of the RLC timer.

According to one or more embodiments of this aspect, the network node is further configured to configure the timer based on a threshold value.

According to one or more embodiments of this aspect, the threshold value is configured based on at least one of an overall buffer utilization and buffers used for a corresponding bearer.

According to another aspect of the present disclosure, a method implemented in a network node is provided. The method includes: configuring a RLC timer, the timer corresponding to a maximum wait time for a missing PDCP SN; and advancing an RLC receiving window based on the missing PDCP SN being one of received and not received before an expiration of the RLC timer.

According to one or more embodiments of this aspect, the timer is an RLC AM timer and includes a duration, the duration being based on a maximum wait time for a missing PDCP SN of an associated PDCP receiver.

According to one or more embodiments of this aspect, the method further includes discarding partially received RLC service data unit, SDU, SN data corresponding to the missing SN; and the discarding being based on the missing SN not being received before the expiration of the RLC timer.

According to one or more embodiments of this aspect, the method further includes triggering a status report based on the missing SN not being received before the expiration of the RLC timer.

According to one or more embodiments of this aspect, the method further includes configuring the timer based on a threshold value.

According to one or more embodiments of this aspect, the threshold value is configured based on at least one of an overall buffer utilization and buffers used for a corresponding bearer.

According to another aspect of the present disclosure, a wireless device configured to communicate with a network node is provided. The wireless device is configured to: configure a RLC timer, the timer corresponding to a maximum wait time for a missing PDCP SN; and advance an RLC receiving window based on the missing PDCP SN being one of received and not received before an expiration of the RLC timer.

According to one or more embodiments of this aspect, the timer is a RLC AM timer and includes a duration, the duration being based on a maximum wait time for a missing PDCP SN of an associated PDCP receiver.

According to one or more embodiments of this aspect, the wireless device is further configured to: discard partially received RLC service data unit, SDU, SN data corresponding to the missing SN; and the discarding being based on the missing SN not being received before the expiration of the RLC timer.

According to one or more embodiments of this aspect, the wireless device is further configured to trigger a status report based on the missing SN not being received before the expiration of the RLC timer.

According to one or more embodiments of this aspect, the wireless device is further configured to configure the timer based on a threshold value.

According to one or more embodiments of this aspect, the threshold value is configured based on at least one of an overall buffer utilization and buffers used for a corresponding bearer.

According to another aspect of the present disclosure, a method implemented in wireless device is provided. The method includes: configuring a RLC timer, the timer corresponding to a maximum wait time for a missing PDCP SN; and advancing an RLC receiving window based on the missing PDCP SN being one of received and not received before an expiration of the RLC timer.

According to one or more embodiments of this aspect, the timer is an RLC AM timer and includes a duration, the duration being based on a maximum wait time for a missing PDCP SN, of an associated PDCP receiver.

According to one or more embodiments of this aspect, the method further includes: discarding partially received RLC service data unit, SDU, SN data corresponding to the missing SN; and the discarding being based on the missing SN not being received before the expiration of the RLC timer.

According to one or more embodiments of this aspect, the method further includes triggering a status report based on the missing SN not being received before the expiration of the RLC timer.

According to one or more embodiments of this aspect, the method further includes configuring the timer based on a threshold value.

According to one or more embodiments of this aspect, the threshold value is configured based on at least one of an overall buffer utilization and buffers used for a corresponding bearer.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of an example process in a wireless device according to some embodiments of the present disclosure;

FIG. 9 is a schematic diagram according to some embodiments of the present disclosure;

FIG. 10 is a flowchart according to some embodiments of the present disclosure;

FIG. 11 is a flowchart according to some embodiments of the present disclosure; and

FIGS. 12A and 12B are a table according to some embodiments of the present disclosure.

### DETAILED DESCRIPTION

Before describing in detail example embodiments, it is noted that the embodiments reside primarily in combinations of apparatus components and processing steps related to an RLC timer procedure for advancing a receive window. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B, or one or both of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide an RLC timer procedure for advancing a receive window.

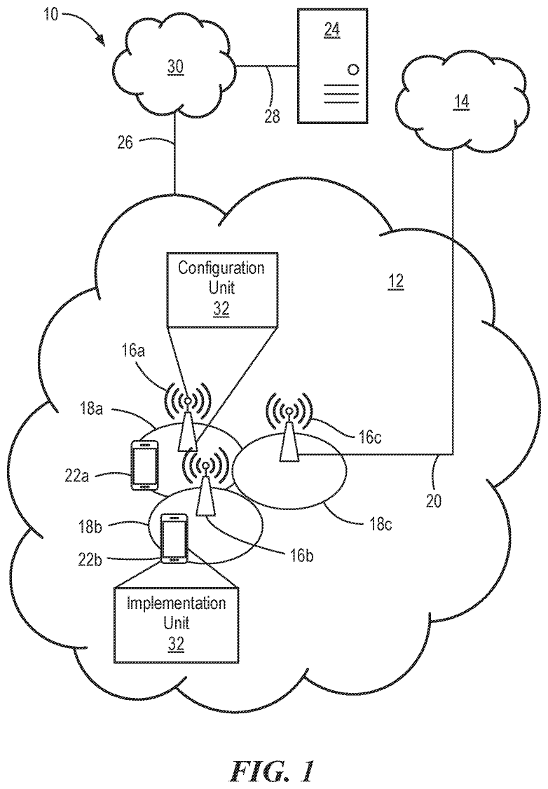

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32, which is configured to perform one or more network node 16 functions described herein, including functions related to an RLC timer procedure for advancing a receive window. A wireless device 22 is configured to include an implementation unit 34, which is configured to perform one or wireless device 22 functions described herein, including functions related to an RLC timer procedure for advancing a receive window.

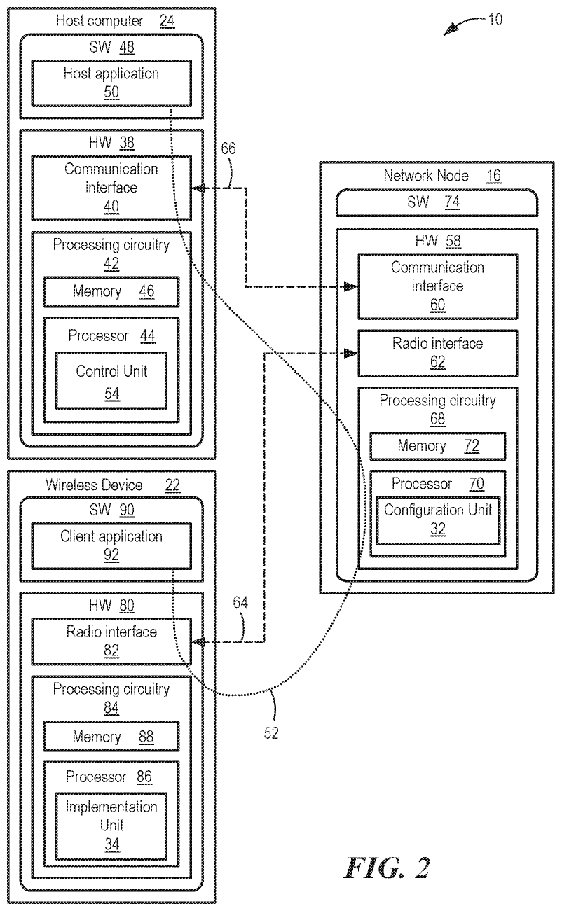

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry/Circuits) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a control unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry/Circuits) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions described herein, including functions related to an RLC timer procedure for advancing a receive window.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry/Circuits) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an implementation unit 34 configured to perform one or wireless device 22 functions described herein, including functions related to an RLC timer procedure for advancing a receive window.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

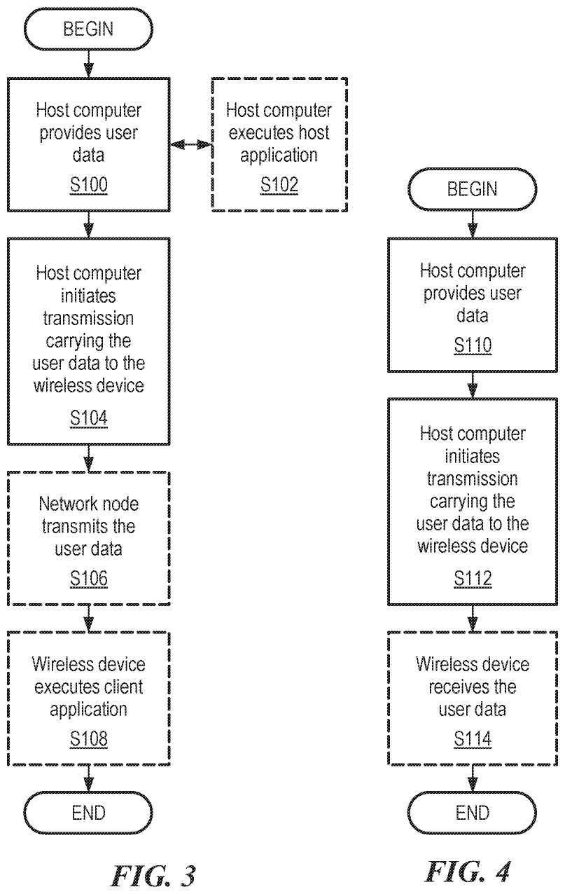

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

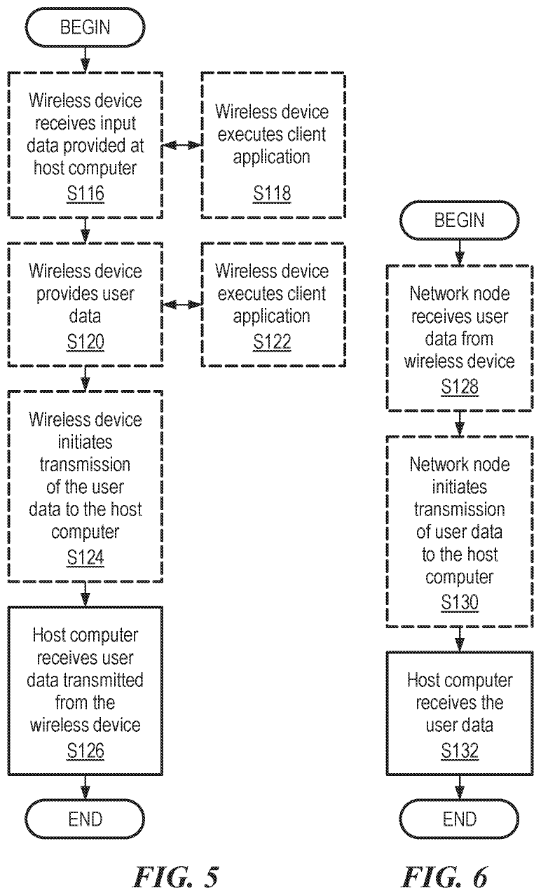

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

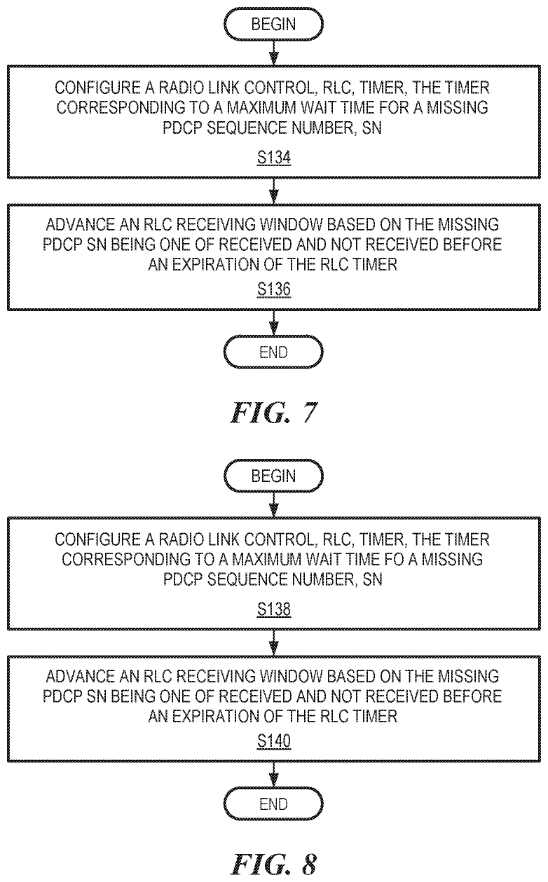

FIG. 7 is a flowchart of an example process in a network node 16. One or more blocks described herein may be performed by one or more elements of network node 16 such as by one or more of processing circuitry 68 (including the configuration unit 32), processor 70, radio interface 62 and/or communication interface 60. Network node 16 is configured to configure a radio link control, RLC, timer, the timer corresponding to a maximum wait time for a missing PDCP sequence number, SN (Block S134). Network node 16 is configured to advance an RLC receiving window based on the missing PDCP SN being one of received and not received before an expiration of the RLC timer (Block S136).

In at least one embodiment, the timer is a RLC Acknowledged Mode (RLC AM) timer and includes a duration, and the duration is based on a maximum wait time for a missing PDCP sequence number, SN, of an associated packet data convergence protocol, PDCP, receiver. In at least one embodiment, the processing circuitry 68 is further configured to discard partially received RLC service data unit, SDU, SN data corresponding to the missing SN based on the missing SN not being received before the expiration of the RLC timer.

In at least one embodiment, the network node 16 is further configured to trigger a status report based on the missing SN not being received before the expiration of the RLC timer. In at least one embodiment, the network node 16 is further configured to configure the timer based on a threshold value. In at least one embodiment, the threshold value is configured based on at least one of an overall buffer utilization and buffers used for a corresponding bearer.

FIG. 8 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to configure a radio link control, RLC, timer, the timer corresponding to a maximum wait time for a missing PDCP sequence number, SN (Block S138). Wireless device 22 is configured to advance an RLC receiving window based on the missing PDCP SN being one of received and not received before an expiration of the RLC timer (Block S140).

In at least one embodiment, the timer is a RLC Acknowledged Mode (RLC AM) timer and includes a duration, and the duration is based on a maximum wait time for a missing PDCP sequence number, SN, of an associated packet data convergence protocol, PDCP, receiver. In at least one embodiment, the processing circuitry 84 is further configured to discard partially received RLC service data unit, SDU, SN data corresponding to the missing SN based on the missing SN not being received before the expiration of the RLC timer.

In at least one embodiment, the network node 16 is further configured to trigger a status report based on the missing SN not being received before the expiration of the RLC timer. In at least one embodiment, the network node 16 is further configured to configure the timer based on a threshold value. In at least one embodiment, the threshold value is configured based on at least one of an overall buffer utilization and buffers used for a corresponding bearer.

Having described the general process flow of arrangements of the disclosure and having provided examples of hardware and software arrangements for implementing the processes and functions of the disclosure, the sections below provide details and examples of arrangements for an RLC timer procedure for advancing a receive window. One or more wireless device 22 functions described below may be performed by one or more of processing circuitry 84, processor 86, implementation unit 34, etc. One or more network node 16 functions described below may be performed by one or more of processing circuitry 68, processor 70, configuration unit 32, etc.

In at least one embodiment, An RLC AM receiver maintains following state variables. State variable (RX_Highest_Pdcp) and timer (t-rxWinAdvance) are added relative to the 3GPP T.S. 38.322 as part of this embodiment. Some existing state variables and the new state variables are summarized below.

Text related to RLC AM receiver actions, as specified in 3GPP T.S. 38.322, are updated in the present disclosure with new clauses shown in underline. Existing actions are shown in plain text and bold. The bold clauses are previously existing clauses for related to t-Reassembly timer re-written into re-usable clauses for more compact text.
RX_Next—receive state variable serves as lower edge or RLC receiving window.
RX_Next_Status_Trigger—holds value of the SN following the SN of the RLC SDU which triggered t-Reassembly.
RX_Highest_Status—holds value highest SN which can be indicated by ACK_SN when a STATUS PDU is formed.
RX_Next_Highest—holds value of the SN following the highest SN received among received RLC SDUs.
t-Reassembly is timer used in receiving AM RLC entity to detect loss of RLC PDUs at lower layers. Essentially, it is used to give time for some lower layer HARQ retransmissions to complete before advancing RX_Highest_Status which limits which ACK/NACK SN can be reported in RLC Status report for ARQ.
RX_Highest_Pdcp—holds the SN following the highest fully received RLC SDU SN and delivered to PDCP receiver.
RX_WinAdvance_Trigger—holds the value of RX_Highest_Pdcp at the time t-rxWinAdvance timer start is triggered.
t-rxWinAdvance—used in receiving AM RLC entity to limit maximum time to wait for a missing RLC SN at lower edge of RLC receive window if a higher RLC SN has already been received and delivered to PDCP receiver.
   Actions when an AMD PDU is Placed in the Reception Buffer

When an AMD PDU with SN=x is placed in the reception buffer, the receiving side of an AM RLC entity shall or may:

| - | if x >= RX_Next_Highest: | |
|---|---|---|
| | ∘ | update RX_Next_Highest to x+ 1. |
| - | if all bytes of the RLC SDU with SN = x are received: | |
| | ∘ | reassemble the RLC SDU from AMD PDU(s) with SN = x, remove RLC |
| | | headers when doing so and deliver the reassembled RLC SDU to upper |
| | | layer; |
| | ∘ | if x = RX_Highest_Status: |

| | |
|---|---|
| ▪ | update RX_Highest_Status to the SN of the first RLC SDU with SN |
| | > current RX_Highest_Status for which not all bytes have been |
| | received. |

| | |
|---|---|
| ∘ | if x = RX_Next: |

| | |
|---|---|
| ▪ | update RX_Next to the SN of the first RLC SDU with SN > current |
| | RX_Next for which not all bytes have been received. |

| | |
|---|---|
| ∘ | if x >= RX_Highest PDCP: |

| | |
|---|---|
| ▪ | update RX_Highest_PDCP to x+1. |

| | ∘ | if t-rxWinAdvance is running, check if t-rxWinAdvance should |
|---|---|---|
| | | be stopped and reset. |
| - | if t-Reassembly is running, check if t-Reassembly should be stopped and reset. | |
| - | if t-Reassembly is not running (includes the case t-Reassembly is stopped due to | |
| | actions above), | |
| | ∘ | Check if t-Reassembly should be started |

Check if t-Reassembly should be stopped and reset

| - | if t-Reassembly is running: | |
|---|---|---|
| | ∘ | if RX_{—}Next_{—}Status_{—}Trigger = RX_{—}Next; or |
| | ∘ | if RX_{—}Next_{—}Status_{—}Trigger = RX_{—}Next + 1 and there is no missing |
| | | byte segment of the SDU associated with SN = RX_{—}Next before the last |
| | | byte of all received segments of this SDU; or |
| | ∘ | if RX_{—}Next_{—}Status_{—}Trigger falls outside of the receiving window and |
| | | RX_{—}Next_{—}Status_{—}Trigger is not equal to RX_{—}Next + |
| | | AM_{—}Window_{—}Size: |

| | |
|---|---|
| ▪ | stop and reset t-Reassembly. |

Actions when t-Reassembly expires
When t-Reassembly expires, the receiving side of an AM RLC entity shall or may:

| | |
|---|---|
| - | update RX_{—}Highest_{—}Status to the SN of the first RLC SDU with SN >= |
| - | RX_{—}Next_{—}Status_{—}Trigger for which not all bytes have been received; |
| - | Check if t-Reassembly should be started. |
| - | Check if t-rxWinAdvance should be started |

Check if t-Reassembly should be started
Checks and Actions to take if t-Reassembly is not already running:

| - | if RX_{—}Next_{—}Highest > RX_{—}Highest_{—}Status +1: or | |
|---|---|---|
| - | if RX_{—}Next_{—}Highest = RX_{—}Highest_{—}Status + 1 and there is at least one missing | |
| | byte segment of the SDU associated with SN = RX_{—}Highest_{—}Status before the | |
| | last byte of all received segments of this SDU: | |
| | ∘ | start t-Reassembly; |
| | ∘ | set RX_{—}Next_{—}Status_{—}Trigger to RX_{—}Next_{—}Highest. |

Check if t-winAdvance should be stopped and reset
if t-rxWinAdvance is running:

| - | if RX_WinAdvance_Trigger = RX_Next; or | |
|---|---|---|
| - | if RX_WinAdvance_Trigger falls outside of the receiving window and | |
| | RX_WinAdvance_Trigger is not equal to RX_Next + AM_Window_Size: | |
| | ∘ | stop and reset t-rxWinAdvance. |

```
Actions when t-rxWinAdvance expires
  If t-rxWinAdvance expires, the receiving side of an AM
  RLC entity shall or may:
```

| - | update RX_Next to the first RLC SN >= RX_WinAdvanceTrigger for | |
|---|---|---|
| | which there is at least one missing byte segment of SDU associated with | |
| | that SN. | |
| - | discard any buffered partially received RLC SDU segments that now | |
| | fall outside the new updated Receiving window. | |
| - | Reset RX_WinAdvanceTrigger. | |
| - | Since RX_Next may have been advanced | |
| | ∘ | if RX_Next >= RX_Highest_Status, then update RX Highest Status |
| | | to the first SN >= RX_Next for which not all bytes have been |
| | ∘ | received; if t-Reassembly is running, check if t-Reassembly should be |
| | | stopped and reset. |

| | |
|---|---|
| ▪ | if t-Reassembly stopped above check if t-Reassembly should |
| | be started. |

| | |
|---|---|
| - | If (RX_Next != RX_Next_Highest), trigger a STATUS report (unless |
| | prohibited by t-StatusProhibit). Otherwise, wait for normal STATUS |
| | report triggers |
| - | Check conditions to start t-rx WinAdvance timer |

Check if t-rxWinAdvance should be started

| - | If t-rxWinAdvance timer not started and | |
|---|---|---|
| - | If (RX_Highest PDCP − RX_Next) > minSduThreshold) | |
| | ∘ | Set RX_WinAdvance_Trigger to RX_Highest PDCP |
| | ∘ | Start t-rxWinAdvanceTimer |
| | ∘ | Here minSduThreshold is some variable that could be as small as |
| | | 1 but could also be a larger initial value and varied as a function |
| | | of overall buffer utilization and buffers used for this bearer. |

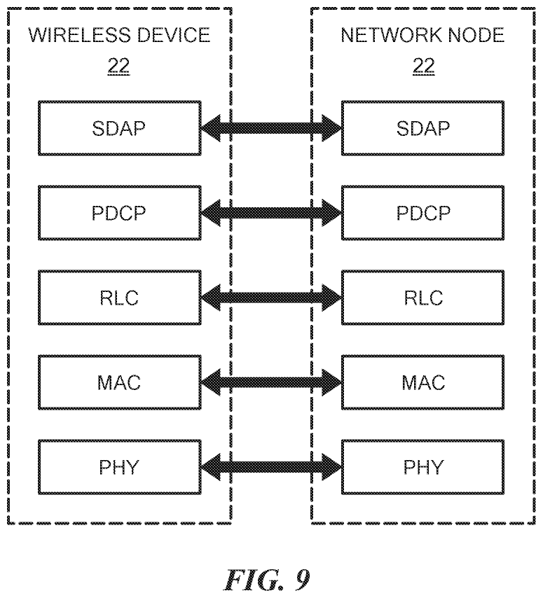

FIG. 9 shows a functional model of user plane PDCP and RLC processing for RLC AM mode.

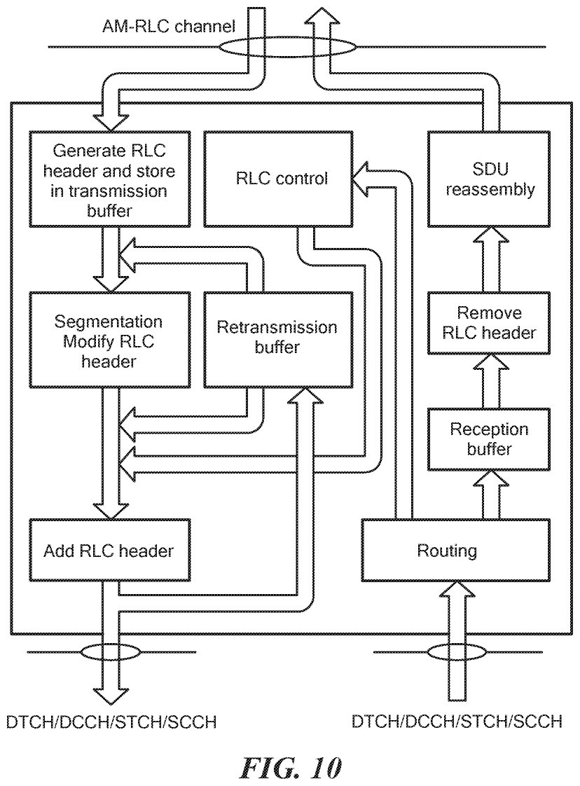

FIG. 10 shows a functional model of an RLC AM mode entity (e.g., according to 3GPP T.S. 38.322).

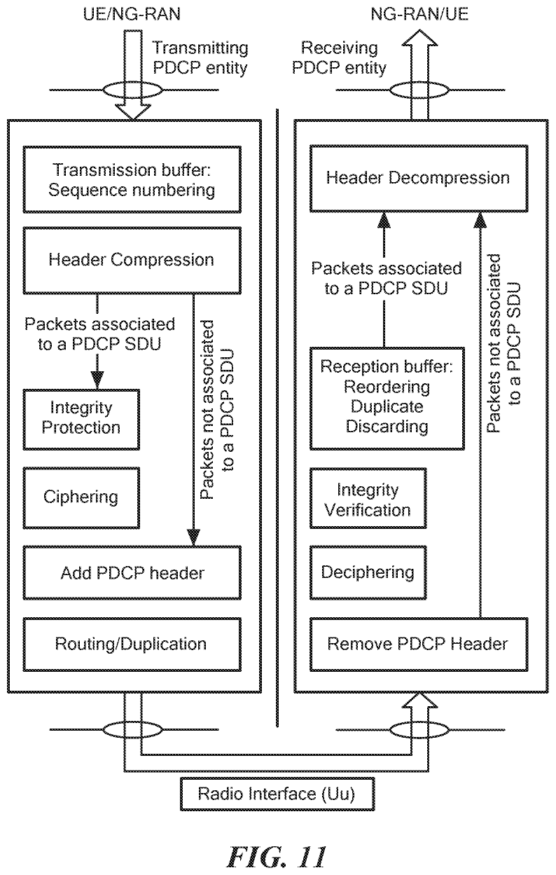

FIG. 11 shows an example NR PDCP functional description, e.g., as specified in 3GPP T.S. 38.323.

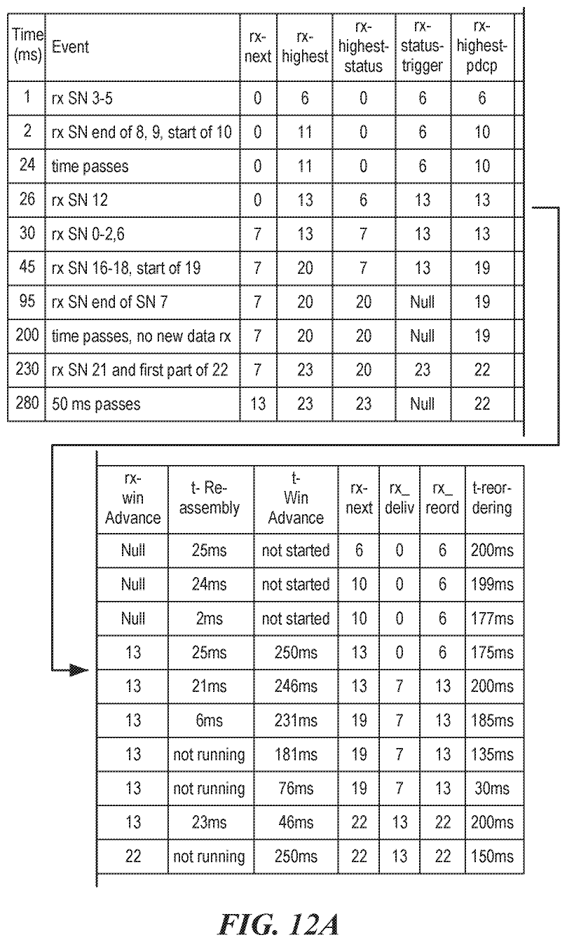

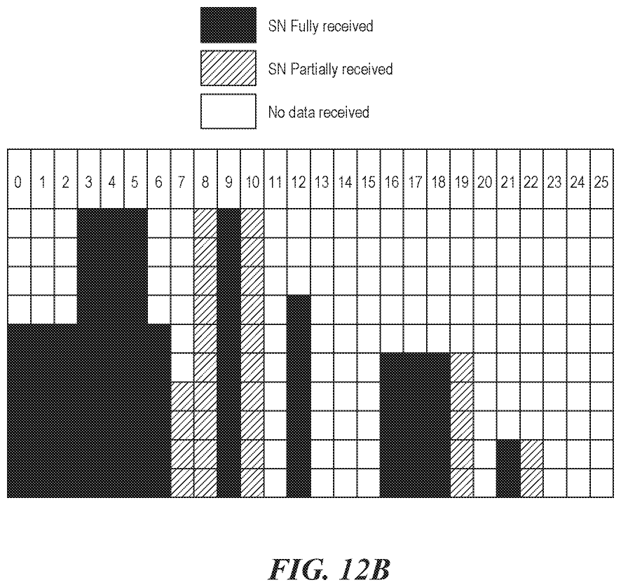

FIGS. 12A and 12B (collectively FIG. 12) show an example of what the RLC AM and PDCP bearer receiver state variables are after processing the received RLC SDU segments received at a given time. For this example, it is assumed that both RLC and PDCP started at initial state at time t=0. For this example, timer values used are as follows, and when timer is started/running, the time remaining until timer expiry is shown in table.

$$t - Reassembly = 25 ms$$

$$t - Reordering = 200 ms$$

$$t - RxWinAdvance = 250 ms$$

With the tWinAdvance timer implemented in RLC receiver, RLC receiver will advance its lower edge of its Rx Window (RX_NEXT) once the tWinAdvance timer expires allowing it to free up buffering resources for partially received SN now outside the new RX window. A STATUS report is triggered, which allows the transmitter to advance its transmit window and avoid further ARQ retransmissions of RLC SDUs no longer of interest to RLC receiver.

Various embodiments in accordance to the present disclosure may be implemented in both embedded and split architectures with cloud deployment. For example, the PDCP function could be deployed in a centralized unit user plane (CU-UP) node that is remote from a distributed unit user plane (DU-UP) node where the RLC layer for bearer is deployed.

### Example Embodiments

Example A1. A network node configured to communicate with a wireless device (WD), the network node configured to, and/or comprising a radio interface and/or comprising processing circuitry configured to:
configure a radio link control, RLC, timer, the timer corresponding to a maximum wait time for a missing PDCP sequence number, SN; and
advance an RLC receiving window based on the missing PDCP SN being one of received and not received before an expiration of the RLC timer.
Example A2. The network node of Example A1, wherein the timer is a RLC Acknowledged Mode (RLC AM) timer and comprises a duration, the duration being based on a maximum wait time for a missing PDCP sequence number, SN, of an associated packet data convergence protocol, PDCP, receiver.
Example A3. The network node of Example A1, the processing circuitry being further configured to:
discard a buffered RLC service data unit, SDU, corresponding to the missing SN (e.g., RLC SDU segments corresponding to partially received or missing SN that are discarded); and
the discarding being based on the missing SN not being received before the expiration of the RLC timer.
Example B1. A method implemented in a network node, the method comprising:
configuring a radio link control, RLC, timer, the timer corresponding to a maximum wait time for a missing PDCP sequence number, SN; and
advancing an RLC receiving window based on the missing PDCP SN being one of received and not received before an expiration of the RLC timer.
Example B2. The method of Example B1, wherein the timer is a RLC Acknowledged Mode (RLC AM) timer and comprises a duration, the duration being based on a maximum wait time for a missing PDCP sequence number, SN, of an associated packet data convergence protocol, PDCP, receiver.
Example B3. The method of Example B1, wherein advancing the receiving window comprises:
discarding a buffered RLC service data unit, SDU, corresponding to the missing SN (e.g., RLC SDU segments corresponding to partially received or missing SN that are discarded); and
the discarding being based on the missing SN not being received before the expiration of the RLC timer.
Example C1. A wireless device (WD) configured to communicate with a network node, the WD configured to, and/or comprising a radio interface and/or processing circuitry configured to:
configure a radio link control, RLC, timer, the timer corresponding to a maximum wait time for a missing PDCP sequence number, SN; and
advance an RLC receiving window based on the missing PDCP SN being one of received and not received before an expiration of the RLC timer.
Example C2. The WD of Example C1, wherein the timer is a RLC Acknowledged Mode (RLC AM) timer and comprises a duration, the duration being based on a maximum wait time for a missing PDCP sequence number, SN, of an associated packet data convergence protocol, PDCP, receiver.
Example C3. The WD of Example C1, the processing circuitry being further configured to:
discard a buffered RLC service data unit, SDU, corresponding to the missing SN (e.g., RLC SDU segments corresponding to partially received or missing SN that are discarded); and
the discarding being based on the missing SN not being received before the expiration of the RLC timer.
Example D1. A method implemented in a wireless device (WD), the method comprising:
configuring a radio link control, RLC, timer, the timer corresponding to a maximum wait time for a missing PDCP sequence number, SN; and
advancing an RLC receiving window based on the missing PDCP SN being one of received and not received before an expiration of the RLC timer.
Example D2. The method of Example D1, wherein the timer is a RLC Acknowledged Mode (RLC AM) timer and comprises a duration, the duration being based on a maximum wait time for a missing PDCP sequence number, SN, of an associated packet data convergence protocol, PDCP, receiver.
Example D3. The method of Example D1, wherein advancing the receiving window comprises:
discarding a buffered RLC service data unit, SDU, corresponding to the missing SN (e.g., RLC SDU segments corresponding to partially received or missing SN that are discarded); and
the discarding being based on the missing SN not being received before the expiration of the RLC timer.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviation Explanation

AM Acknowledged Mode
ARQ Automatic Repeat Request
BLER Block Error Rate
CU-UP Centralized Unit-User Plane
DU-UP Distribute Unit-User Plane
HARQ Hybrid ARQ
PDCP Packet Data Convergence Protocol
PDU Protocol Data Unit
RLC Radio Link Control
SDU Service Data Unit
SN Sequence Number
TM Transparent Mode
UE User Equipment
UM Unacknowledged Mode

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, the network node comprising processing circuitry configured to:
configure a radio link control, RLC, timer, the timer corresponding to a maximum wait time for a missing packet data convergence protocol, PDCP, sequence number, SN; and
advance an RLC receiving window based on the missing PDCP SN being one of received and not received before an expiration of the RLC timer.

2. The network node of claim 1, wherein the timer is a RLC Acknowledged Mode, RLC AM, timer and comprises a duration, the duration being based on a maximum wait time for a missing PDCP sequence number, SN, of an associated packet data convergence protocol, PDCP, receiver.

3. The network node of claim 1, the processing circuitry being further configured to:
discard partially received RLC service data unit, SDU, SN data corresponding to the missing SN; and
the discarding being based on the missing SN not being received before the expiration of the RLC timer.

4. The network node of claim 1, the processing circuitry being further configured to:
trigger a status report based on the missing SN not being received before the expiration of the RLC timer.

5. The network node of claim 1, the processing circuitry being further configured to:
configure the timer based on a threshold value, the threshold value being configured based on at least one of an overall buffer utilization and buffers used for a corresponding bearer.

6. (canceled)

7. A method implemented in a network node, the method comprising:
configuring a radio link control, RLC, timer, the timer corresponding to a maximum wait time for a missing packet data convergence protocol, PDCP, sequence number, SN; and
advancing an RLC receiving window based on the missing PDCP SN being one of received and not received before an expiration of the RLC timer.

8. The method of claim 7, wherein the timer is a RLC Acknowledged Mode, RLC AM, timer and comprises a duration, the duration being based on a maximum wait time for a missing PDCP sequence number, SN, of an associated packet data convergence protocol, PDCP, receiver.

9. The method of claim 7, further comprising:
discarding partially received RLC service data unit, SDU, SN data corresponding to the missing SN; and
the discarding being based on the missing SN not being received before the expiration of the RLC timer.

10. The method of claim 7, further comprising:
triggering a status report based on the missing SN not being received before the expiration of the RLC timer.

11. The method of claim 7, further comprising:
configuring the timer based on a threshold value, the threshold value being configured based on at least one of an overall buffer utilization and buffers used for a corresponding bearer.

12. (canceled)

13. A wireless device configured to communicate with a network node, the wireless device comprising processing circuitry configured to:
configure a radio link control, RLC, timer, the timer corresponding to a maximum wait time for a missing packet data convergence protocol, PDCP, sequence number, SN; and
advance an RLC receiving window based on the missing PDCP SN being one of received and not received before an expiration of the RLC timer.

14. The wireless device of claim 13, wherein the timer is a RLC Acknowledged Mode, RLC AM, timer and comprises a duration, the duration being based on a maximum wait time for a missing PDCP sequence number, SN, of an associated packet data convergence protocol, PDCP, receiver.

15. The wireless device of claim 13, the processing circuitry being further configured to:
discard partially received RLC service data unit, SDU, SN data corresponding to the missing SN; and
the discarding being based on the missing SN not being received before the expiration of the RLC timer.

16. The wireless device of claim 13, the processing circuitry being further configured to:
trigger a status report based on the missing SN not being received before the expiration of the RLC timer.

17. The wireless device of claim 13, the processing circuitry being further configured to:
configure the timer based on a threshold value, the threshold value being configured based on at least one of an overall buffer utilization and buffers used for a corresponding bearer.

18. (canceled)

19. A method implemented in a wireless device, the method comprising:
configuring a radio link control, RLC, timer, the timer corresponding to a maximum wait time for a missing packet data convergence protocol, PDCP, sequence number, SN; and
advancing an RLC receiving window based on the missing PDCP SN being one of received and not received before an expiration of the RLC timer.

20. The method of claim 19, wherein the timer is a RLC Acknowledged Mode, RLC AM, timer and comprises a duration, the duration being based on a maximum wait time for a missing PDCP sequence number, SN, of an associated packet data convergence protocol, PDCP, receiver.

21. The method of claim 19, further comprising:
discarding partially received RLC service data unit, SDU, SN data corresponding to the missing SN; and
the discarding being based on the missing SN not being received before the expiration of the RLC timer.

22. The method of claim 19, further comprising:
triggering a status report based on the missing SN not being received before the expiration of the RLC timer.

23. The method of claim 19, further comprising:
configuring the timer based on a threshold value, the threshold value being configured based on at least one of an overall buffer utilization and buffers used for a corresponding bearer.

24. (canceled)
